(19) United States
(12) Patent Application Publication
(10) Pub. No.: US 2008/0201752 A1
(43) Pub. Date: Aug. 21, 2008

(54) Multicast data packet recovery system

(75) Inventors: Kuo-Hui Liu, San Ramon, CA (US); Donald M. Smith, San Ramon, CA (US)

Correspondence Address: SCHWEGMAN, LUNDBERG & WOESSNER, P.A., P.O. BOX 2938, MINNEAPOLIS, MN, 55402, US

(73) Assignee: AT&T Knowledge Ventures, L.P.

(21) Appl. No.: 11/707,792

(22) Filed: Feb. 16, 2007

(51) Int. Cl. H04N 7/173; H04J 1/16; H04L 12/28

(52) U.S. Cl. 725/114; 370/216; 370/390

(57) ABSTRACT

Particular embodiments of the disclosed subject matter provide methods and systems to support a multicast data packet recovery system. In an example embodiment, the system includes a distribution server operable to detect a missed data packet in a multicast data stream; issue a request for a retransmission of the missed data packet to an acquisition server via a unicast data channel; receive the requested data packet via a multicast data channel, in response to the request for a retransmission of the missed data packet; and send the requested data packet to one or more subscribers.

### TECHNICAL FIELD

The disclosed subject matter relates to the field of data packet transmission on a network, and more particularly to systems and methods supporting multicast data packet transmission.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2006, SBC Knowledge Ventures L.P. All Rights Reserved.

### BACKGROUND

Conventional systems provide the capability for unicast data packet transmission between a specific sender and a specific receiver. These unicast data packet transmission systems also include a capability to re-transmit a lost or corrupted packet in the unicast data stream. However, as the quantity of networked computer users grows and network bandwidth demands increase, unicast data transmission systems cannot deliver enough efficiency to meet the demand.

Multicast data transmission systems can deliver data packets to multiple consumers from a single source. Multicast data transmission systems can deliver data packets containing the same information to least two receiving entities simultaneously or nearly simultaneously. As such, multicast data transmission systems can provide a higher level of efficiency when the quantity of networked computer users grows and network bandwidth demands increase. For these reasons, multicast data transmission systems are often used in video applications, for example, where high levels of network efficiency are needed. However, in multicast data transmission systems, the handling of lost or corrupted packets is more complicated because any given data packet may be consumed by more than one receiver. The conventional unicast method of re-transmitting a lost or corrupt data packet to a specific receiver is not efficient when a multicast network is available.

Thus, a multicast data packet recovery system is needed.

### BRIEF DESCRIPTION OF THE DRAWINGS

FIG. 1 illustrates an example multicast network architecture in a particular embodiment.

FIGS. 2, 3, and 4 illustrate a video distribution network in accordance with one example embodiment of the disclosed subject matter hereof.

FIGS. 5, 6, 7, and 8 illustrate a data packet recovery architecture in a multicast distribution network in accordance with various example embodiments of the disclosed subject matter hereof.

FIGS. 9, 10, and 11 illustrate various data packet recovery architectures in a multicast distribution network with national multicast termination servers (NMT-servers) in accordance with various example embodiments of the disclosed subject matter hereof.

FIG. 12 illustrates an example computer system.

FIGS. 13-17 illustrate various embodiments of the methods described herein.

### DETAILED DESCRIPTION

In the following detailed description, reference is made to the accompanying drawings that form a part hereof, and in which are shown by way of illustration, specific embodiments in which the disclosed subject matter can be practiced. It is understood that other embodiments may be utilized and structural changes may be made without departing from the scope of the disclosed subject matter.

As described further below, according to various example embodiments of the disclosed subject matter described herein, there is provided a multicast data packet recovery system. The system can include a computer program embedded within the memory and executable by the processor, the computer program comprising instructions to implement a multicast data packet recovery system.

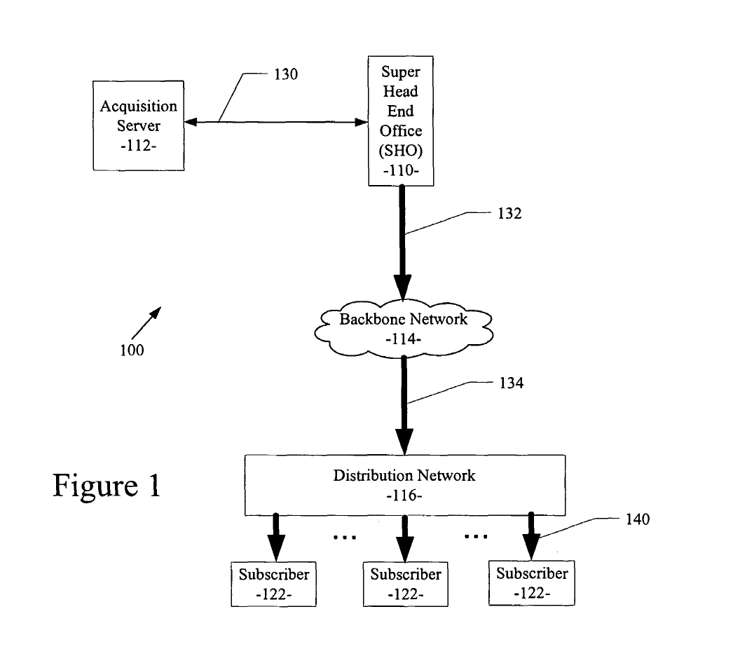

In one example embodiment, an Internet Protocol Television (IPTV) network provides an infrastructure for the real-time delivery of video content (or other forms of content) to large numbers of customers/viewers. In an IPTV network, digitized video content is partitioned into data packets that are transported/delivered to customers via the IPTV network. In conventional implementations, IPTV transport is very sensitive to data packet loss. Any packet loss associated with a video stream will introduce artifacts and lower the video quality perceived by customers/viewers. In one example embodiment, an IPTV network implementation uses an IP multicast approach to distribute video streams from a Super Head End Office (SHO) to a Video Hub Office (VHO) and in turn to all the Set Top Boxes (STBs) at customer locations. An example of such an IP multicast network is described below in connection with FIGS. 1-4.

Referring to FIG. 1, a multicast network architecture in a particular embodiment is illustrated. As shown in FIG. 1, the network 100 may include a super head end office (SHO) 110 for acquisition and encoding of video content, for example, received from an acquisition server 112 via a data communication channel 130. SHO 110 can then multicast this video content to a plurality of subscribers 122 via a backbone network 114 and a distribution network 116. It is to be understood that subscribers 122 as used herein refers to a subscriber device for receiving and rendering a content stream. In this example, data streams 132, 134, and 140 are multicast data streams for receipt and consumption by the plurality of subscribers 122. Because of the quantity of subscribers in a desired network, a conventional network, such as backbone network 114, could not handle the bandwidth requirements of a unicast data transmission to each of the subscribers 122. As such, a multicast data transmission of video content to subscribers 122 is necessary. However, if a data packet in the multicast data transmission is lost or corrupted in transmission, one or more subscribers 122 may be affected. Therefore, an effective means for enabling a subscriber 122 to request a retransmission of a lost or corrupted data packet in the multicast data transmission is required. This means for enabling a subscriber 122 to request a retransmission in the multicast data transmission is described in more detail below in connection with a particular embodiment. The distribution network 116 in a particular embodiment is also described in more detail below.

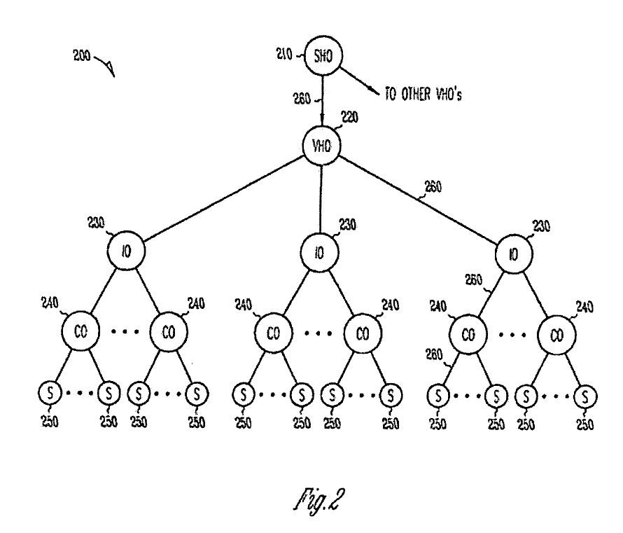

Referring now to FIGS. 2, 3, and 4, there is illustrated one example embodiment of a video distribution system or network 200, using a multicast data packet transmission model. As shown in FIG. 2, the network 200 may include a super head end office (SHO) 210 for acquisition and encoding of video content, one or more video hub offices (VHO) 220 in each demographic market area (DMA), one or more intermediate offices (IO) 230, one or more central offices (CO) 240 located in each metropolitan area, and, finally, the subscribers (S) 250, who may be located in single or multiple dwelling units. In one example embodiment, the network 200 may be connected through a plurality of high speed communication links 260 using physical transport layers such as fiber, cable, twisted pair, air, or other media.

In one example embodiment of the video delivery system, the SHO 210 distributes content to one or more VHOs 220, which may be spread across a wide geographic territory, such as an entire country. The SHO 210 may, for example, be in a central location for acquisition and aggregation of national-level broadcast TV (or linear) programming. A redundant SHO 210 may be provided for backup in case of failure. Linear programming may be received at the SHO 210 via satellite and processed for delivery to the VHO 220. The VHOs 220 are the video distribution points within each demographic market area (DMA) or geographic region.

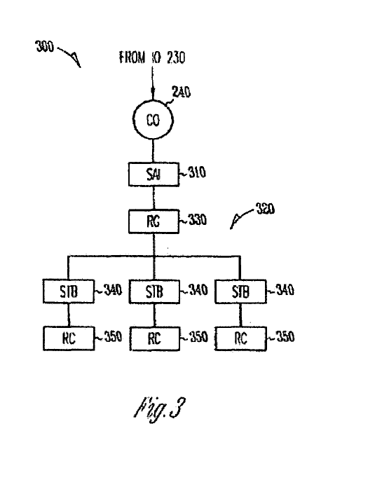

Referring now to FIG. 3, there is illustrated, in more detail, an example network architecture 300 between the CO 240 and the subscriber 250. A serving area interface (SAI) 310 may be connected to the CO 240. SAI 310 may, for example, be located in a weather-proof enclosure proximate the subscriber 250 premises, and may include fiber-to-the-node (FTTN) equipment. FTTN equipment may also be located in the CO 240. Customer premise equipment (CPE) 320 includes, for example, a network interface device (NID) and a residential gateway (RG) 330, with a built-in very-high-bit-rate digital subscriber loop (VDSL) modem or optical network termination (ONT). In either case, the RG 330 may be connected to the rest of the home set top boxes (STB) 340 via an internal network such as an Ethernet. Each STB 340 has an associated remote control (RC) 350 which provides data entry to the STB 340 to control the broadcast selections from the video distribution data streams.

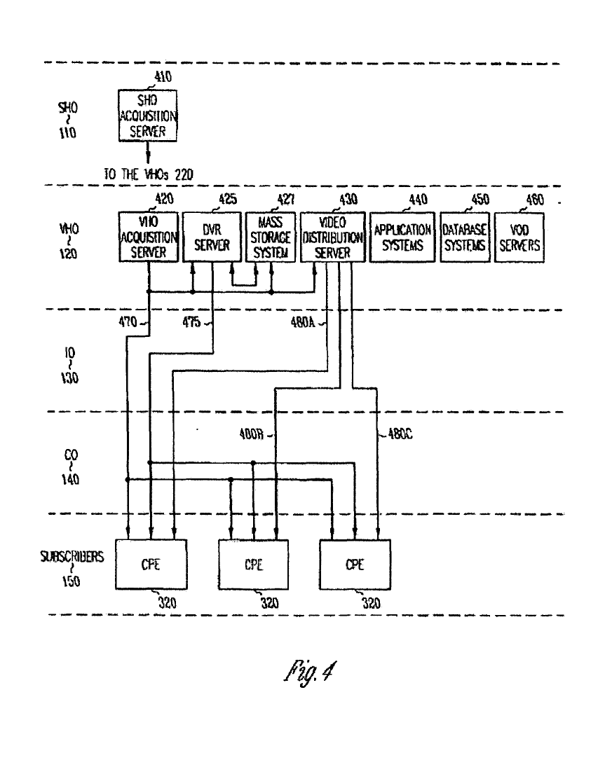

Referring now to FIG. 4, which illustrates one example embodiment of a configuration according to the disclosed subject matter, a SHO acquisition server 410 may be used to acquire national content that may be distributed towards the VHO 220. In an alternative embodiment, live television content may be acquired using an acquisition server in the VHO 220. In this configuration, the VHO 220 may include a live television acquisition server 420 and a video distribution server 430, which forward the live television and/or other content toward the subscribers 250 through the intermediate offices (IOs) 230 and the central office (CO) 240. A VHO 220 may also include application systems 440, regional subscriber 250 database systems 450, and VOD servers 460. The COs 240 are connected to the IOs 230 to further distribute traffic towards the subscribers 250. Traffic may reach the subscribers 250 at least partially via either fiber to the node (FTTN) or fiber to the premises (FTTP), or by other types of transmission medium.

As also illustrated in FIG. 4, acquisition server 420 may distribute a plurality of live television programs, each typically associated with a television “channel,” using a multicast IP protocol data stream 470 through the IOs 230 and COs 240 to the subscribers 250. The routers, switches, and other network elements that would normally be present in the IOs 230 and COs 240 are not shown in FIG. 4 in order to simplify the drawing. The number of programs or channels sent using multicast may, without limitation, range up to 800 channels or more using present technology, with it being understood that advances in technology may allow many more channels to be sent.

The multicast protocol allows for efficient distribution of these signals to a large number of end subscribers 250. In addition, the video distribution server 430 receives the multicast data stream 470, and distributes selected ones of the live television signals, extracted from the stream 470, using a unicast data stream 480a, 480b, or 480c, to specific subscribers 250. In this embodiment, video distribution server 430 may provide a unicast stream, for example in burst mode, of a specific live television channel to any of the subscribers 250 served by the VHO 220. The burst mode instant channel change data stream can be discontinued once the subscriber's 250 system is loaded with enough TV program data so that the multicast stream can “catch up” and take over supplying the program data stream in the multicast mode for more extended term viewing by the subscriber 250.

According to one embodiment, access to regularly scheduled programming on the television channels may be controlled by a STB 340 in the subscriber 250's premises. Thus, in one example embodiment, each subscriber 250 receives live television programs from the video acquisition server 420 based on IP-based multicasting services, while the video distribution servers 430 can be used to provide subscribers 250 “instant” channel change and recover some video packet losses to maintain acceptable quality of service. Further, the DVR server 425 can be included to provide recorded television programming upon demand by the subscribers 250.

Although the system and method as described above is shown in an example form implemented in a video distribution system, the disclosed system and method may, in another example embodiment, may be implemented in a cable television system, in a broadcast television system, in a satellite distribution system, in a wireless distribution system, or in other data packet distribution systems.

To deal with the potential packet loss impact to video quality due to random bit error rate or network failures, prior art systems (e.g. Microsoft) have implemented Reliable UDP (R-UDP) protocols to recover the lost packets between the SHO and VHOs and between the VHOs and STBs. The original implementation uses unicast transmissions for packet recovery. Because unicast transmissions are used for packet recovery, the SHO is required to send unicast transmissions to thousands of servers (D-Servers) in the VHOs one by one with the information related to the same lost packets. This prior art unicast solution has proven to be un-scalable and inefficient. The prior art solution cannot recover most of the lost packets for most of the servers in the VHOs whenever there are packet loss events in the backbone network between the SHO and VHOs.

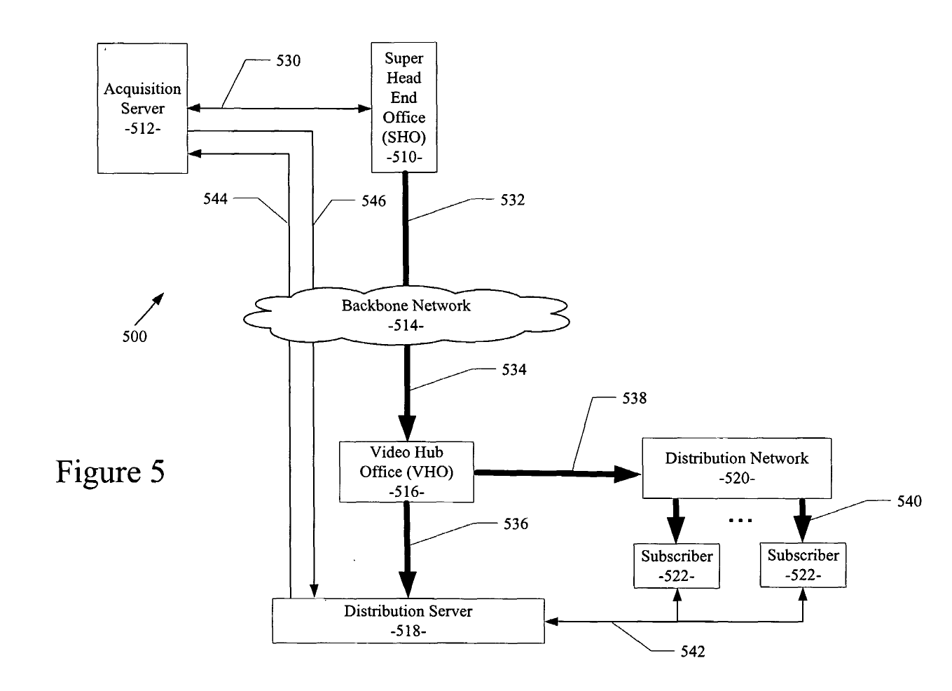

Referring now to FIG. 5, one alternative embodiment of a data packet recovery architecture is illustrated. As shown in FIG. 5, the network 500 may include a super head end office (SHO) 510 for acquisition and encoding of video content, for example, received from an acquisition server 512 via a data communication channel 530. SHO 510 can then multicast this video content to a plurality of subscribers 522 via a backbone network 514, a video hub office (VHO) 516, and a distribution network 520, such as the distribution network described above. In a particular embodiment, distribution network 520 can include a combination of VHO, IO, CO, SAI, and RG, as described above. In the example shown in FIG. 5, data streams 532, 534, 538, and 540 are multicast data streams for receipt and consumption by the plurality of subscribers 522. In addition, network 500 includes a distribution server 518. Distribution server 518 also receives the multicast data stream on line 536. Distribution server 518 can support subscribers 522 by handling the processing necessary to request and receive retransmission of lost or corrupt data packets in the multicast data stream 532, 534, 536, 538, and 540. Upon detection of a lost or corrupt (i.e. missed) data packet in the multicast data stream by the distribution server 518 or a subscriber 522, distribution server 518 can issue a request for a retransmission of the missed data packet to acquisition server 512 via a unicast data channel 544. The unicast data channel 544 can use backbone network 514, but can use an alternative network as well. The request for a retransmission of the missed data packet can include the identity, sequence number, or the like to identify the missed packet. In response to the request for a retransmission of the missed data packet, the acquisition server 512 sends the requested data packet to the distribution server 518 via a unicast data channel 546 as shown in FIG. 5. The unicast data channel 546 can also use backbone network 514, but can use an alternative network as well. Upon receipt of the requested data packet from the acquisition server 512, the distribution server 518 can send the requested data packet to one or more subscribers 522 on a unicast data channel 542. The subscribers 522 can use the data packet identity, sequence number, or the like to insert the missed packet into the video sequence in the proper position for viewing by a subscriber. Subscribers 522 can also use the unicast data channel 542 to notify the distribution server 518 that a data packet has been missed in the multicast data stream.

Although the particular embodiment illustrated in FIG. 5 provides an effective solution for handling the retransmission of missed data packets in the multicast data stream, the use of unicast data transmission between distribution server 518 and acquisition server 512 and between distribution server 518 and subscribers 522 can be overwhelmed if many data packets are lost or corrupted in the multicast data stream. The problem can be exacerbated if consecutive data packets are lost in the multicast data stream. In some cases, the bandwidth capacity for the unicast data channels in handling retransmission requests may be exceeded.

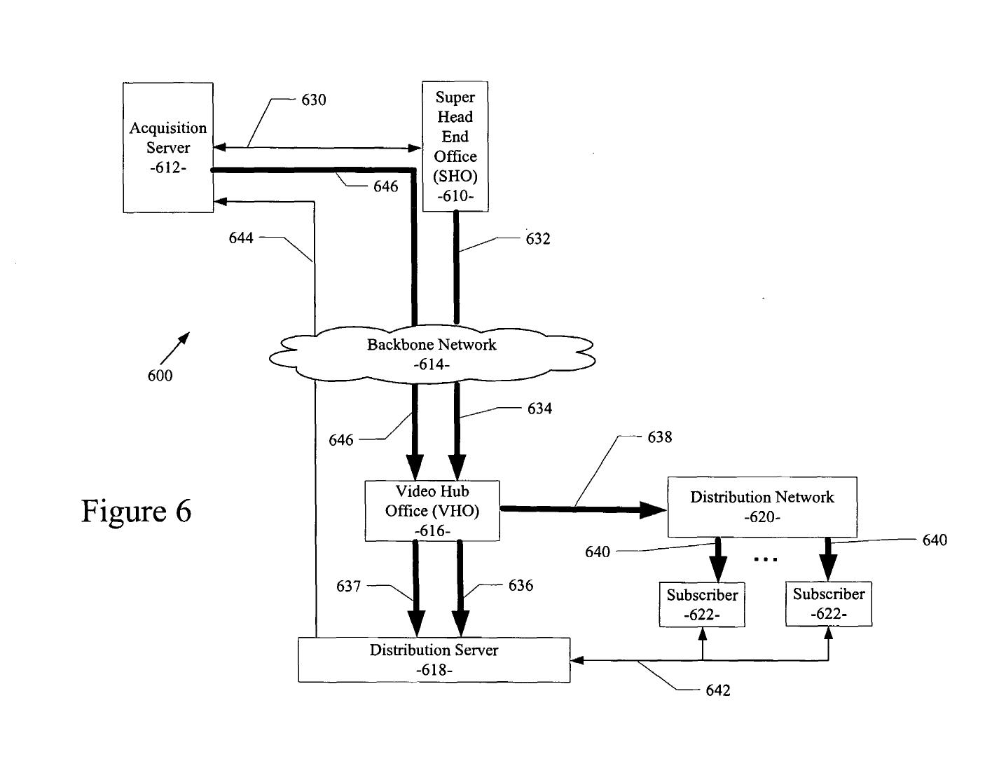

Referring now to FIG. 6, an alternative embodiment of a data packet recovery architecture is illustrated. As shown in FIG. 6, the network 600 may include a super head end office (SHO) 610 for acquisition and encoding of video content, for example, received from an acquisition server 612 via a data communication channel 630. SHO 610 can then multicast this video content to a plurality of subscribers 622 via a backbone network 614, a video hub office (VHO) 616, and a distribution network 620, such as the distribution network described above. In a particular embodiment, distribution network 620 can include a combination of VHO, IO, CO, SAI, and RG, as described above. In the example shown in FIG. 6, data streams 632, 634, 638, and 640 are multicast data streams for receipt and consumption by the plurality of subscribers 622. In addition, network 600 includes a distribution server 618. Distribution server 618 also receives the multicast data stream on line 636. Distribution server 618 can support subscribers 622 by handling the processing necessary to request and receive retransmission of lost or corrupt data packets in the multicast data stream 632, 634, 636, 638, and 640. However, in the example embodiment of FIG. 6, distribution server 618 can request that the retransmission of lost or corrupt data packets occur in the multicast data stream and not in a unicast data stream. As such, the embodiment of FIG. 6 differs in this respect from the example embodiment shown in FIG. 5.

Referring to the embodiment shown in FIG. 6, upon detection of a lost or corrupt (i.e. missed) data packet in the multicast data stream by the distribution server 618, distribution server 618 can issue a request for a retransmission of the missed data packet to acquisition server 612 via a unicast data channel 644. The unicast data channel 644 can use backbone network 614, but can use an alternative network as well. The request for a retransmission of the missed data packet can include the identity, sequence number, or the like to identify the missed packet. In response to the request for a retransmission of the missed data packet, the acquisition server 612 can send the requested data packet or packets to the distribution server 618 via a multicast data channel 646 and 637 (for distribution server 618) as shown in FIG. 6. The multicast data channel 646 can also use backbone network 614. In an example embodiment, the acquisition server 612 responds to the request for a retransmission of the missed data packet by sending the requested data packet to all connected distribution servers and subscribers via a multicast data channel to which the distribution servers and subscribers are tuned/connected. Note that the retransmitted data packets can be added to the primary multicast data stream 632, 634, and 636 and transmitted to the distribution server 618 just as any other multicast data packet. The multicast retransmission of missed data packets is shown in FIG. 6 as a separate multicast transmission 646 and 637 merely for clarity. Upon receipt of the multicast re-transmission of the requested data packet or packets from the acquisition server 612, the distribution server 618 can send the requested data packet or packets to one or more subscribers 622 on a unicast data channel 642. In an example embodiment, a subscriber 622 can request the requested data packet or packets from the distribution server 618 on the unicast data channel 642. The subscribers 622 can use the data packet identity, sequence number, or the like to insert the missed packet into the video sequence in the proper position for viewing by a subscriber. Subscribers 622 can also use the unicast data channel 642 to notify the distribution server 618 that a data packet has been missed in the multicast data stream.

The particular embodiment illustrated in FIG. 6 provides an effective solution for handling the retransmission of missed data packets in the multicast data stream. In the embodiment of FIG. 6, the unicast data channels are not as likely to be overrun by multiple requests for the retransmission of missed data packets.

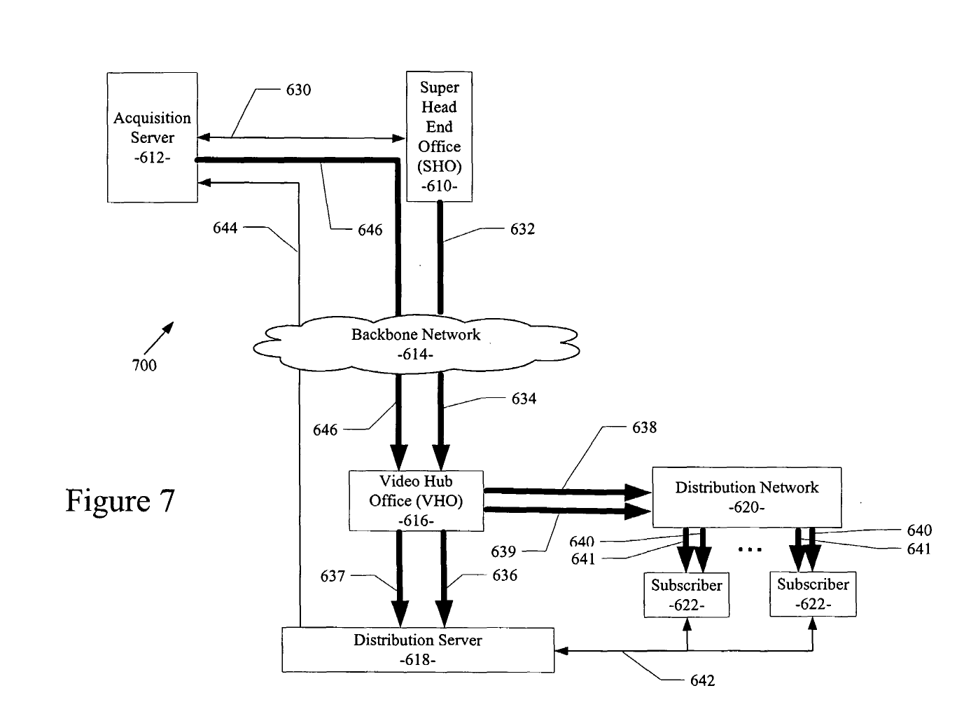

Referring now to FIG. 7, an alternative embodiment of a data packet recovery architecture is illustrated. As shown in FIG. 7, the network 700 may include a super head end office (SHO) 610 for acquisition and encoding of video content, for example, received from an acquisition server 612 via a data communication channel 630. SHO 610 can then multicast this video content to a plurality of subscribers 622 via a backbone network 614, a video hub office (VHO) 616, and a distribution network 620, such as the distribution network described above. In the example shown in FIG. 7, data streams 632, 634, 638, and 640 are multicast data streams for receipt and consumption by the plurality of subscribers 622. In addition, network 700 includes a distribution server 618. Distribution server 618 also receives the multicast data stream on line 636. Distribution server 618 can support subscribers 622 by handling the processing necessary to request and receive retransmission of lost or corrupt data packets in the multicast data stream 632, 634, 636, 638, and 640. However, in the example embodiment of FIG. 7, distribution server 618 can request that the retransmission of lost or corrupt data packets occur in the multicast data stream and not in a unicast data stream. Further, the retransmission of missed data packets is multicast directly to the subscribers 622 (and/or any distribution servers connected/tuned to the multicast data channel). As such, the embodiment of FIG. 7 differs in this respect from the example embodiments shown in FIG. 5.

Referring to the embodiment shown in FIG. 7, upon detection of a lost or corrupt (i.e. missed) data packet in the multicast data stream by the distribution server 618 or a subscriber 622, distribution server 618 can issue a request for a retransmission of the missed data packet to acquisition server 612 via a unicast data channel 644. In response to the request for a retransmission of the missed data packet, the acquisition server 612 can send the requested data packet or packets to the distribution server 618 and subscribers 622 via a multicast data channel 646 and 637 (for distribution server 618) and multicast data channel 646, 639, and 641 (for subscribers 622) as shown in FIG. 7. The multicast data channel 646 can also use backbone network 614. In an example embodiment, the acquisition server 612 responds to the request for a retransmission of the missed data packet by sending the requested data packet to all connected distribution servers and subscribers via a multicast data channel to which the distribution servers and subscribers are tuned/connected. Note that the retransmitted data packets can be added to the primary multicast data stream 632, 634, 636, 638, and 640 and transmitted to the distribution server 618 and subscribers 622 just as any other multicast data packet. The multicast retransmission of missed data packets is shown in FIG. 7 as a separate multicast transmission 646, 637, 639, and 641 merely for clarity. Upon receipt of the multicast re-transmission of the requested data packet or packets from the acquisition server 612, the distribution server 618 and the subscribers 622 can use the data packet identity, sequence number, or the like to insert the missed packet into the video sequence in the proper position for viewing by a subscriber. Subscribers 622 can also use the unicast data channel 642 to notify the distribution server 618 that a data packet has been missed in the multicast data stream.

The particular embodiment illustrated in FIG. 7 provides an effective solution for handling the retransmission of missed data packets in the multicast data stream directly to the subscribers. In the embodiment of FIG. 7, the unicast data channels are even less likely to be overrun by multiple requests for the retransmission of missed data packets.

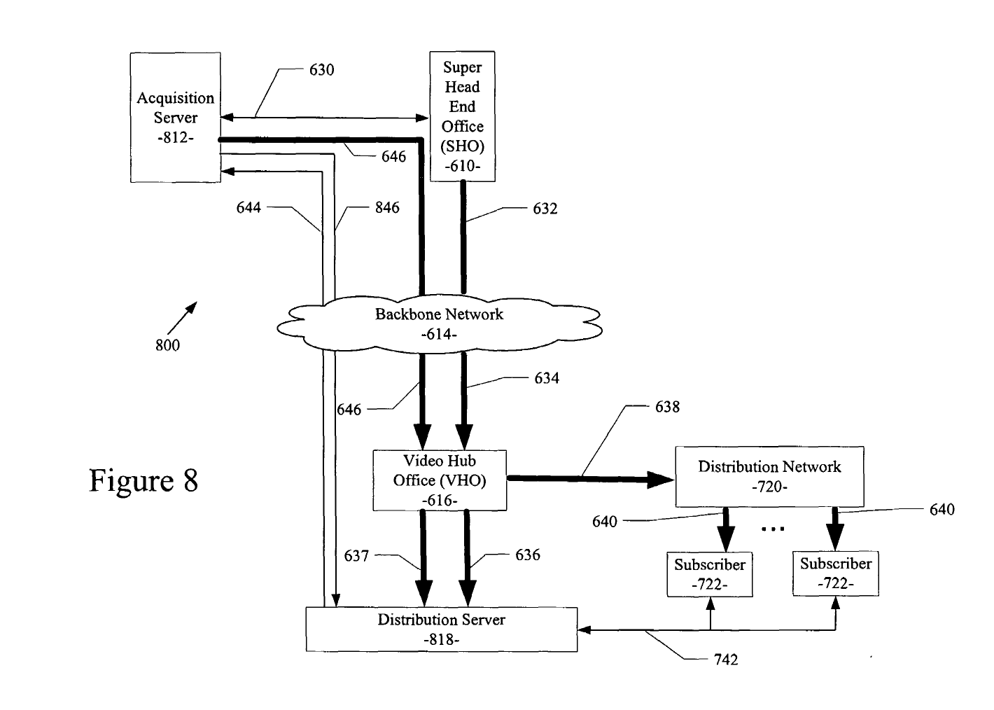

Referring now to FIG. 8, an alternative embodiment of a data packet recovery architecture is illustrated. As shown in FIG. 8, the network 800 represents a combination of the example embodiments shown in FIGS. 5, 6, and 7. In the example embodiment of FIG. 8, the network 800 can use a unicast data channel 846 to retransmit a missed data packet from the acquisition server 812 to the distribution server 818 in a manner described above. Alternatively, multicast channel 646 can be used to retransmit a missed data packet from the acquisition server 812 to the distribution server 818 and subscribers 722 on a multicast channel. Depending on the types and locations of data packet losses, network 800 can selectively choose a unicast or a multicast channel to retransmit the missed data packets. In this way, the network 800 can choose the most efficient way to respond to data packet retransmissions in a multicast system. The choice to use multicast or unicast for retransmission can be made by the acquisition server based, for example, on the number of retransmission requests for a particular missing data packet. If the acquisition server receives N-multicast-threshold requests for the same missing packet within a time period up to T-count-requests, then the resend will be multicast. If the number of requests in time T-count-requests is less than N-multicast-threshold, the resend will be unicast to the requesting distribution servers. In this manner, the acquisition server can dynamically choose the most efficient channel for retransmitting missed data packets.

In the example embodiments described above, the acquisition server can use a multicast tree or the like for the handling of one or more requests for a retransmitted data packet. The acquisition server can thereby react to a first request for a particular data packet retransmission and suppress subsequent requests for the retransmission of the same data packet. The suppression of subsequent requests for the retransmission of the same data packet can be implemented for a particular pre-determined time period.

In the various example embodiments described herein, the problems with prior art systems is solved by using the original video multicast network for packet recovery. Instead of sending thousands of copies of the lost packets through the backbone network, only one copy of the retransmitted packets associated with a channel will be sent to the VHOs through the original multicast tree of this channel for the recovery of lost packets in the backbone. The various example embodiments described herein are scalable and will greatly reduce the traffic load on the backbone.

Two additional alternative embodiments for processing the multicast packet streams as they arrive in the VHO are presented below. In the first alternative embodiment, the multicast stream is forwarded without interruption to the distribution servers (D-Servers) and toward the STBs as described above. In a second alternative embodiment, the multicast stream is terminated in National Channel Multicast Termination Servers (NMT-Servers). The NMT-Servers run R-UDP with the SHO in order to recover lost packets and subsequently act as multicast sources for the downstream receivers.

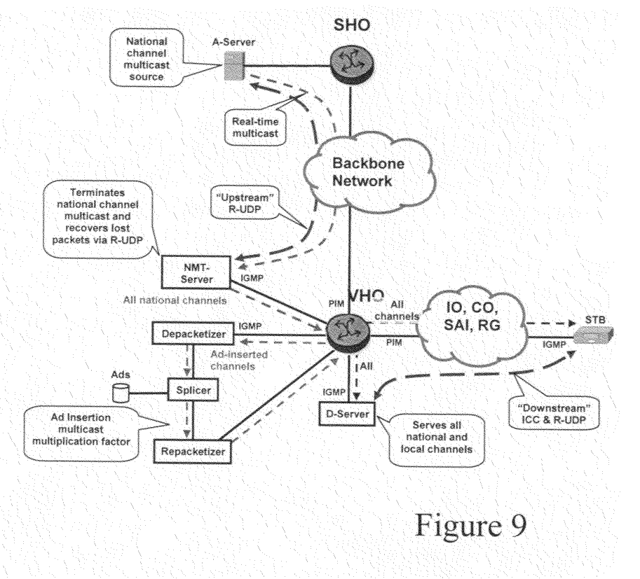

It is possible to terminate all the multicast streams received from the SHO, including streams into which advertisements (Ads) will be inserted in the VHO and streams which will not have Ads inserted in the VHO. In this case, the multicast receivers of the output of the NMT-Servers for channels without VHO Ad Insertion are the D-Servers and STBs, and for channels with Ad Insertion in the VHO the receivers are servers within the Ad Insertion system. An example embodiment of an NMT-server system architecture for handling all national channels is illustrated in FIG. 9. In FIG. 9, IGMP and PIM are references to standard multicast related protocols that deal with requests to join and leave multicast groups.

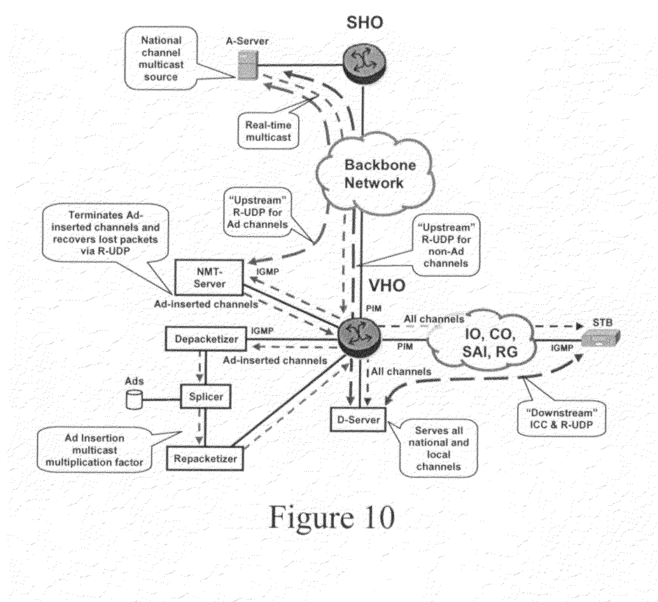

It is also possible to apply NMT only to streams into which Ads will be inserted in the VHO. In this case, the streams without VHO ad insertion operate as in the original implementation, that is, they are multicast to the D-Servers and downstream toward the STBs, and R-UDP operates between the STBs and D-Servers and between the D-Servers and the SHO for these steams. The streams with Ad Insertion in the VHO are terminated in the NMT-Servers and forwarded to the Ad Insertion system. The output of the Ad Insertion system is then multicast to the D-Servers and toward the STBs. In this case, R-UDP operates between the NMT-Servers and the SHO only for these streams, and R-UDP operates between the D-Servers and the STBs for all channels. An example embodiment of an NMT-server system architecture for handling local ad-inserted channels is illustrated in FIG. 10.

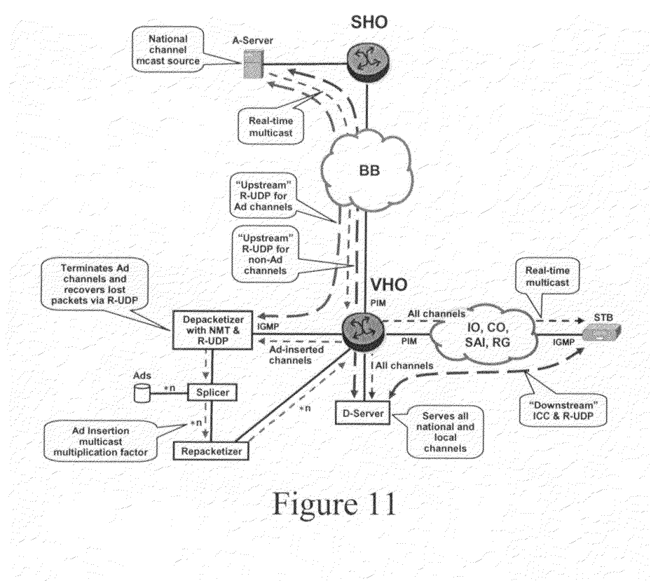

When NMT is applied only to streams into which Ads will be inserted in the VHO, the NMT-Servers may be standalone devices or their functions may be incorporated into servers inside the Ad Insertion system. These example embodiments will eliminate the need for packet recovery between the STBs and servers in the VHO whenever there are packet loss events in the backbone. Another example embodiment of an NMT-server system architecture for handling local ad-inserted channels is illustrated in FIG. 11.

The various example embodiments described herein solve the scalability issue of the packet loss recovery of a multicast video distribution network. Given that the video multicast network uses a multicast tree to distribute video streams from SHO to all VHOs, any packet loss event depending on where it happens on the tree may not necessary impact all the servers in the VHOs. Therefore, naturally people consider using unicast approach for packet recovery. However, the unicast cast approach has been proven to be unscalable. For example, assume 40 VHOs and only two servers out of each VHO receiving the video streams from the SHO. The best performance based on the current technology to recover a link failure today is 50 msecs failover time. Assume that for the live video we have only one second to recover the lost packets to avoid the artifacts. Also assume that if the total video streams have aggregated traffic of 1.5 Gbps, then it will require 6 Gbps bandwidth reserved for packet loss recovery. In fact, the number of servers in each VHO will be hundreds instead of two in our example here. The bandwidth required for packet loss recovery for a scaled deployment using unicast is 600 Gbps assuming there are 200 servers receiving these streams from the SHO.

The various embodiments described herein address this issue through multicast packet recovery approach over the original multicast tree. This approach requires only a fixed percentage of total multicast traffic bandwidth reserved for packet loss recovery to recover any lost packets in the backbone due to random packet errors or packet errors/loss due to link failures.

The NMT-Server approach solves two problems. First, depending on where in the backbone a packet loss event occurs, some VHOs may suffer packet loss while others do not. When multicast re-transmitted packets arrive in VHOs which did not request re-transmission, if NMT-Servers are implemented, they will observe that these are duplicates and not forward them downstream. Without NMT-Servers, the duplicate packets will be forwarded toward the STBs. Secondly, the NMT-Server approach allows R-UDP to work between the VHOs and SHOs for channels that have advertising inserted in the VHOs. Without NMT-Servers, this type of R-UDP would not work for those channels, and unrecoverable packet loss would be propagated to the STBs served by the affected VHOs. The reason R-UDP (without NMT) does not work for the Ad inserted channels is that the sequence number space from the Ad insertion system, which is sent to the distribution server, is not the same as the sequence number space from the acquisition server.

The various embodiments described herein leverage the original video multicast tree for backbone packet loss recovery. The servers in the SHO will only respond to the first of the R-UDP requests sent by servers in the VHOs for the same lost packets of a specific channel by sending the re-transmitted packets through the multicast tree associated with this channel. All down stream servers tune to receive this channel will all receive the normal stream and also the packet recovery stream. Without NMT-Servers, down stream servers and STBs not impacted by the packet loss event will just throw away the packets received from the recovery stream if these servers have already successfully received these packets through normal stream. The servers in the SHO will have to suppress the remaining R-UDP requests for a period longer than the largest difference of the propagation delays between the servers in the VHOs and the server in the SHO plus the largest difference of the packet gap detection times but shorter than the time delay for the downstream servers in the VHOs between their first request attempt and the second request attempt if the first request attempt does not successfully result in packet recovery for the lost packets.

The solutions described herein have several advantages. These solutions are very scalable and will only require a fixed percentage of aggregated multicast video traffic bandwidth for packet recovery and the amount of bandwidth required is independent of the numbers of down stream VHOs and servers in these VHOs. Further, these solutions eliminate the need for the STBs to request packets lost in the backbone through the servers in the VHOs using unicast R-UDP re-transmission.

The various embodiments described herein use a novel multicast approach for packet loss recovery for any packet errors/loss in the backbone between the SHO and VHOs. They address the scalability issues of packet recovery using a unicast approach with very minimum amount of bandwidth reserved for packet recovery purpose. They also eliminate the processing loads of servers in the VHOs to handle the concurrent R-UDP requests from downstream STBs due to packet error/loss events in the backbone. Note that any packet error/loss in the backbone will trigger simultaneous R-UDP re-transmission requests from all STBs tuned to a specific channel to the corresponding servers in the VHOs.

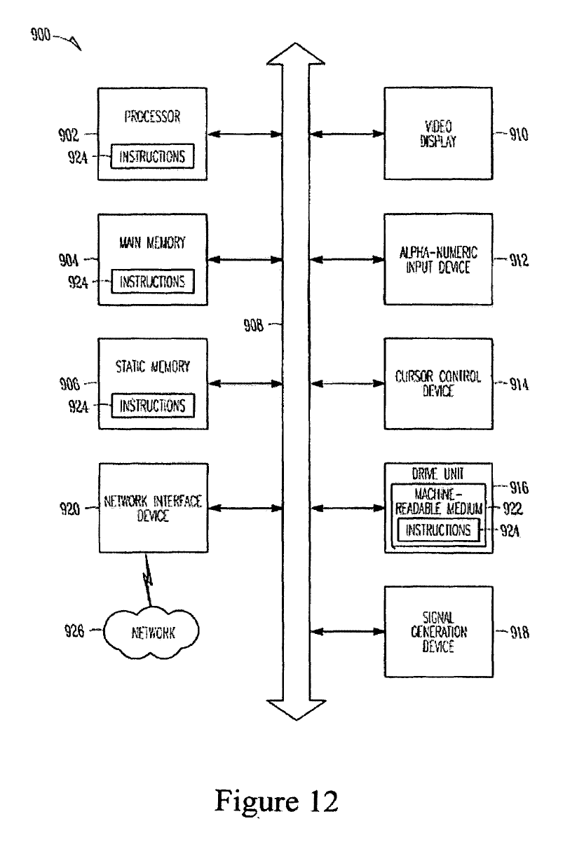

Referring now to FIG. 12, a diagrammatic representation of a machine is shown in the example form of a computer system 900 of a type sufficient for use in any of the example embodiments set forth herein. System 900 may include a set of instructions for causing the machine to perform any one or more of the methodologies discussed herein, that may be executed. In alternative embodiments, the machine operates as a standalone device or may be connected (e.g., networked) to other machines. In a networked deployment, the machine may operate in the capacity of a server, a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904, and/or within the processor 902, during execution thereof by the computer system 900. The main memory 904 and the processor 902 may also constitute machine-readable media.

The software 924 may further be transmitted or received over a network 926 via the network interface device 920 utilizing any one of a number of well-known transfer protocols, for example, the hyper text transfer protocol (HTTP). While the machine-readable medium 922 is shown in an example embodiment to be a single medium, the term “machine-readable medium” as an article of manufacture should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the disclosed subject matter, or that is capable of storing, encoding, or carrying data structures utilized by or associated with such a set of instructions. The term “machine-readable medium” shall accordingly be taken to include, but not be limited to, solid-state memories, optical and magnetic media, and carrier wave signals.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In conjunction with the configuration of structure and methods described herein, a multicast data packet recovery system is described. In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

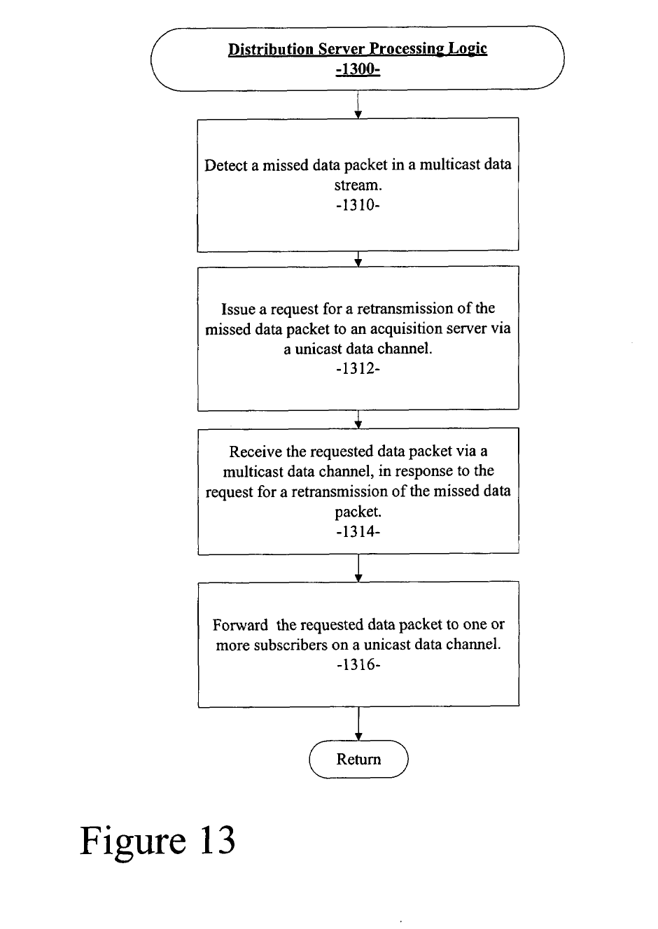

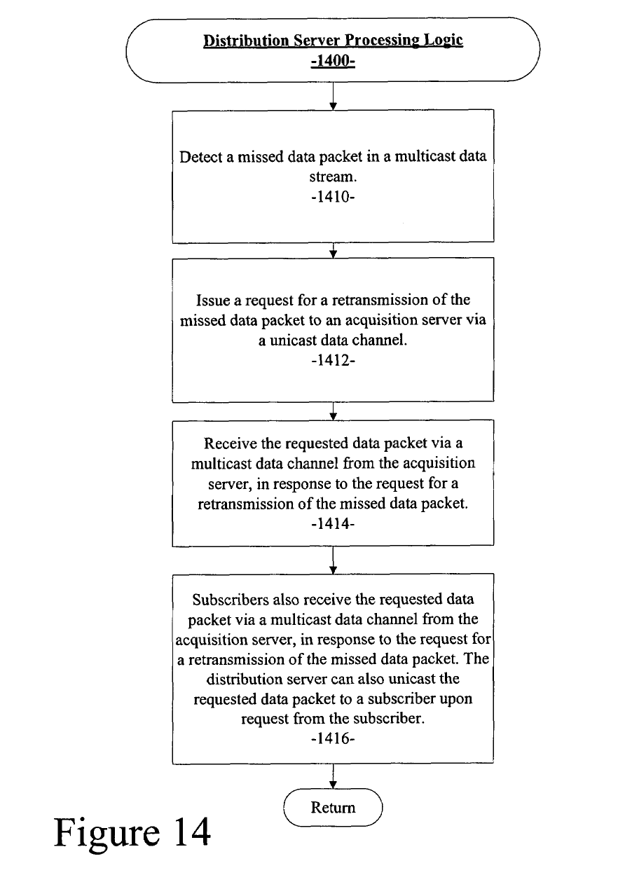

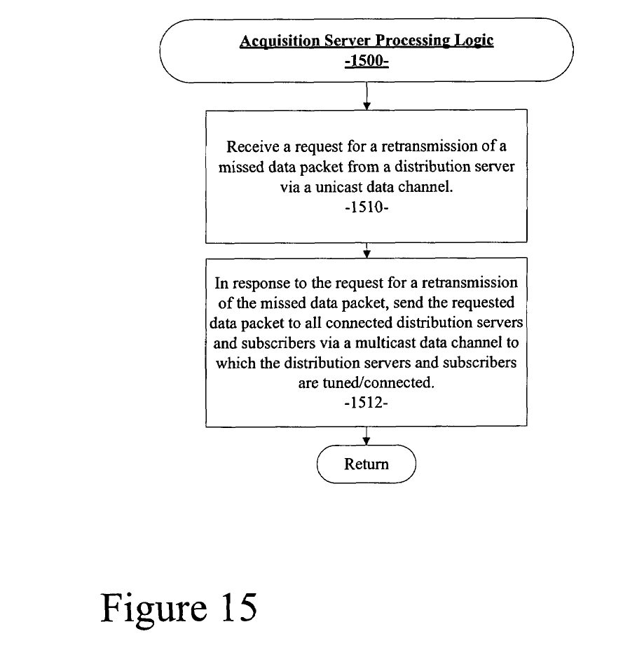

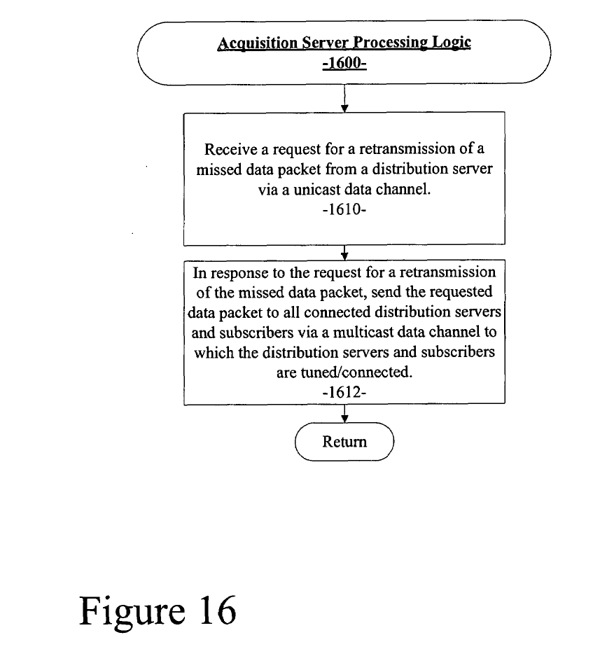

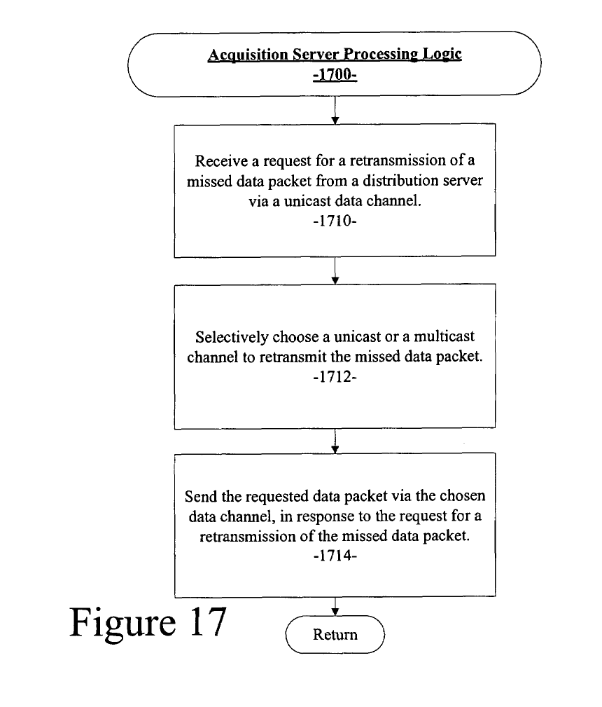

FIGS. 13-17 are processing flow diagrams illustrating various methods related to example embodiments in accordance with the disclosed subject matter.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of ordinary skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a distribution server operable to:
detect a missed data packet in a multicast data stream;
issue a request for a retransmission of the missed data packet to an acquisition server via a unicast data channel;
receive the requested data packet via a multicast data channel, in response to the request for a retransmission of the missed data packet; and
send the requested data packet to one or more subscribers.

2. The system as claimed in claim 1 wherein the request for a retransmission includes a data packet identity sufficient to enable insertion of the requested data packet into a content sequence in the proper position for consumption by a user.

3. The system as claimed in claim 1 wherein the detection of a missed data packet includes receiving a notification from a subscriber via a unicast channel that a data packet has been missed in the multicast data stream.

4. The system as claimed in claim 1 wherein the multicast data stream includes video content.

5. The system as claimed in claim 1 wherein the requested data packet is sent to one or more subscribers via a second unicast data channel.

6. The system as claimed in claim 1 wherein the requested data packet is sent to one or more subscribers via a second multicast data channel.

7. A system comprising:
an acquisition server operable to:
receive a request for transmission of a data packet from a distribution server via a unicast data channel; and
send the requested data packet to a distribution server via a multicast data channel, in response to the request for transmission of the data packet.

8. The system as claimed in claim 7 wherein the request for transmission includes a data packet identity sufficient to enable insertion of the requested data packet into a content sequence in the proper position for consumption by a user.

9. The system as claimed in claim 7 wherein the multicast data stream includes video content.

10. The system as claimed in claim 7 wherein the request for transmission of a data packet includes a request for retransmission of a missed data packet.

11. A system comprising:
an acquisition server operable to:
receive a request for transmission of a data packet from a distribution server via a unicast data channel; and
send the requested data packet to a subscriber via a multicast data channel, in response to the request for transmission of the data packet.

12. The system as claimed in claim 11 wherein the request for transmission includes a data packet identity sufficient to enable insertion of the requested data packet into a content sequence in the proper position for consumption by a user.

13. The system as claimed in claim 11 wherein the multicast data stream includes video content.

14. The system as claimed in claim 11 wherein the request for transmission of a data packet includes a request for retransmission of a missed data packet.

15. A system comprising:
an acquisition server operable to:
receive a request for transmission of a data packet from a distribution server via a unicast data channel;
selectively choose a unicast or a multicast channel to transmit the data packet; and
send the requested data packet via the chosen data channel, in response to the request for transmission of the data packet.

16. The system as claimed in claim 15 wherein the request for transmission includes a data packet identity sufficient to enable insertion of the requested data packet into a content sequence in the proper position for consumption by a user.

17. The system as claimed in claim 15 wherein the multicast data stream includes video content.

18. The system as claimed in claim 15 wherein the request for transmission of a data packet includes a request for retransmission of a missed data packet.

19. A system comprising:
a national multicast termination (NMT) server operable to:
detect a missed data packet in a multicast data stream;
issue a request for a retransmission of the missed data packet to an acquisition server via a unicast data channel;
receive the requested data packet via a multicast data channel, in response to the request for a retransmission of the missed data packet; and
send via a multicast data channel the requested data packet to a downstream device.

20. The system as claimed in claim 19 wherein the request for a retransmission includes a data packet identity sufficient to enable insertion of the requested data packet into a content sequence in the proper position for consumption by a user.

21. The system as claimed in claim 19 wherein the multicast data stream includes video content.

22. A method comprising:
detecting a missed data packet in a multicast data stream;
issuing a request for a retransmission of the missed data packet to an acquisition server via a unicast data channel;
receiving the requested data packet via a multicast data channel, in response to the request for a retransmission of the missed data packet; and
sending the requested data packet to one or more subscribers.

23. The method as claimed in claim 22 wherein the request for a retransmission includes a data packet identity sufficient to enable insertion of the requested data packet into a content sequence in the proper position for consumption by a user.

24. The method as claimed in claim 22 wherein the detection of a missed data packet includes receiving a notification from a subscriber via a unicast channel that a data packet has been missed in the multicast data stream.

25. The method as claimed in claim 22 wherein the multicast data stream includes video content.

26. The method as claimed in claim 22 wherein the requested data packet is sent to one or more subscribers via a second unicast data channel.

27. The method as claimed in claim 22 wherein the requested data packet is sent to one or more subscribers via a second multicast data channel.

28. A method comprising:
receiving a request for transmission of a data packet from a distribution server via a unicast data channel; and
sending the requested data packet to a distribution server via a multicast data channel, in response to the request for transmission of the data packet.

29. The method as claimed in claim 28 wherein the multicast data stream includes video content.

30. An article of manufacture comprising at least one machine readable storage medium having one or more computer programs stored thereon and operable on one or more computing systems to: detect a missed data packet in a multicast data stream; issue a request for a retransmission of the missed data packet to an acquisition server via a unicast data channel; receive the requested data packet via a multicast data channel, in response to the request for a retransmission of the missed data packet; and send the requested data packet to one or more subscribers.

31. An article of manufacture according to claim 30 wherein the multicast data stream includes video content.
